(19) United States
(12) Patent Application Publication
(10) Pub. No.: US 2012/0180958 A1
(43) Pub. Date: Jul. 19, 2012

(54) Sunshade Assembly Having a Buffer Unit

(76) Inventor: Paul Lin, Tainan City (TW)

(21) Appl. No.: 13/007,715

(22) Filed: Jan. 17, 2011

(51) Int. Cl. E06B 9/44

(52) U.S. Cl. 160/127

(57) ABSTRACT

A sunshade assembly includes a housing having a top opening, a winding shaft mounted rotatably in the housing, a sunshade cloth wound around the winding shaft, a pull rod connected to the sunshade cloth and disposed external to the top opening, a tubular casing mounted below the housing, a guide rod extending downward from the pull rod and slidable in the tubular casing, a buffer disposed beside the tubular casing to provide a buffer resistance to the guide rod, and a driven member driven by the guide rod and moving the buffer. When the sunshade cloth is moved by the winding shaft to a wound position from a stretched position external to the housing, the guide rod is moved downward along with the pull rod until the guide rod pushes downward the driven member, thereby reducing a downward moving speed of the guide rod.

### BACKGROUND OF THE INVENTION

1. Field of the Invention

The invention relates to a sunshade, and more particularly to a sunshade assembly that is adapted to be installed on a side window of a vehicle and that has a sunshade cloth which can be wound automatically.

2. Description of the Related Art

Referring to FIG. 1, a conventional sunshade assembly 1 includes a housing 11 having a top opening 111, a winding shaft 12 mounted rotatably in the housing 11, a sunshade cloth 13 wound around the winding shaft 12, a pull rod 14 connected to one end 131 of the sunshade cloth 13 that is distal from the winding shaft 12, and a hanging seat 15 for hanging of the pull rod 14 when the sunshade cloth 13 is unwound from the winding shaft 12.

To use the conventional sunshade assembly 1, the user pulls out the sunshade cloth 13 from the housing 11 via the top opening 111, and the pull rod 14 is hung on the hanging seat 15, thereby placing the sunshade cloth 13 in a stretched position. When the pull rod 14 is removed from the hanging seat 15, the sunshade cloth 12 is quickly wound back onto the winding shaft 12. However, the quick winding of the sunshade cloth 12 back onto the winding shaft 12 can result on impact between the pull rod 14 and the housing 11 due to inertia. The impact may generate noise and cause vibration in the components of the conventional sunshade assembly. Hence, the conventional sunshade curtain 1 lacks sophistication, and is not suitable for use in luxury cars.

### SUMMARY OF THE INVENTION

Therefore, the object of the present invention is to provide a sunshade assembly that has a buffer unit which can prevent production of noise and vibration when a sunshade cloth is moved from a stretched position to a wound position.

According to this invention, a sunshade assembly comprises a sunshade unit, a guide unit, and a buffer unit. The sunshade unit includes a housing having a top opening, a winding shaft mounted rotatably in the housing, a sunshade cloth wound around the winding shaft, and a pull rod connected to one end of the sunshade cloth that is distal from the winding shaft and disposed external to the top opening. The guide unit includes a tubular casing mounted below the housing and extending in a top-bottom direction, and a guide rod extending downward from the pull rod and slidable in the tubular casing. The buffer unit includes a buffer disposed beside the tubular casing to provide a buffer resistance to the guide rod, and a driven member driven by the guide rod and that moves the buffer. When the sunshade cloth is moved by the winding shaft to a wound position from a stretched position external to the housing, the guide rod is moved downward along with the pull rod until the guide rod pushes downward the driven member, thereby reducing a downward moving speed of the guide rod.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional sunshade assembly;

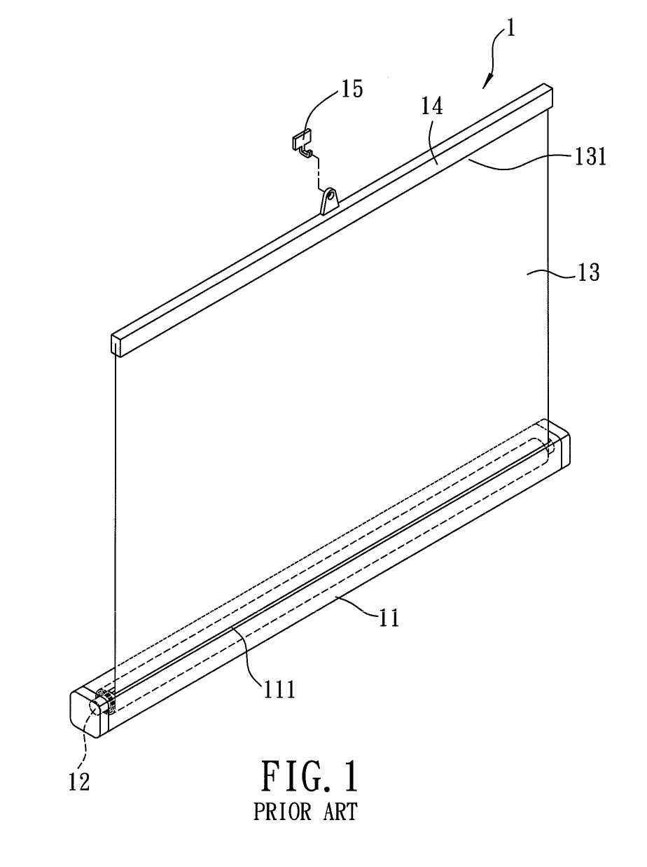

FIG. 2 is a partial sectional view of a sunshade assembly according to the first preferred embodiment of the present invention;

FIG. 3 is a view similar to FIG. 2, but illustrating a sunshade cloth in a wound position;

FIG. 4 is a fragmentary sectional view of a sunshade assembly according to the second preferred embodiment of the present invention;

FIG. 5 is a view similar to FIG. 4, but illustrating a biasing element in a compressed state; and

FIG. 6 is a fragmentary sectional view of a sunshade assembly according to the third preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

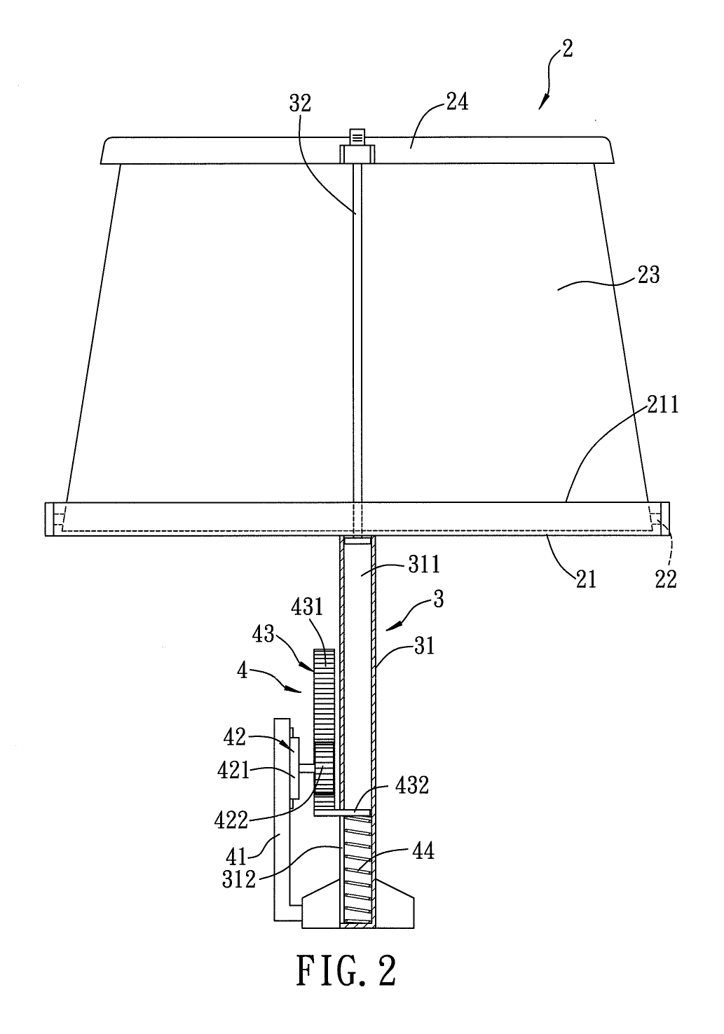

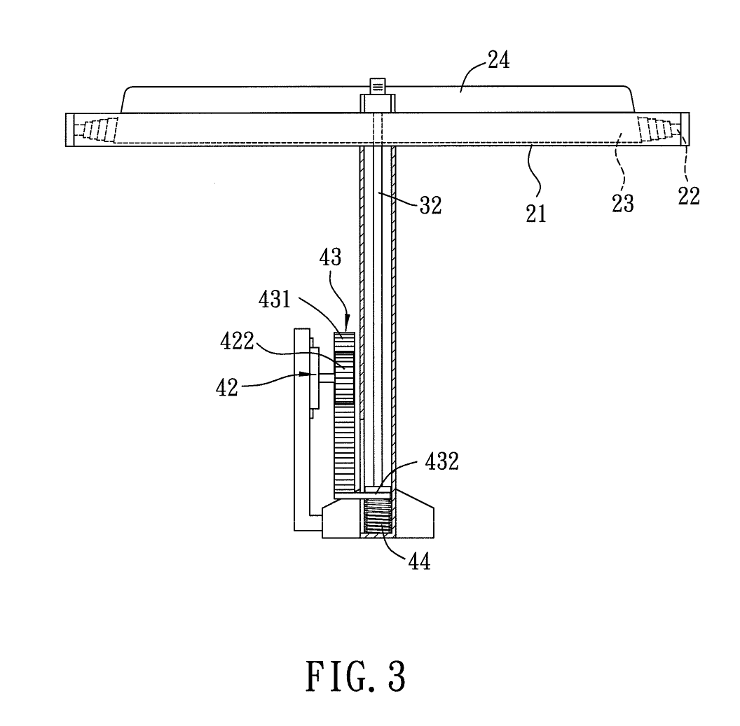

Referring to FIGS. 2 and 3, a sunshade assembly according to the first preferred embodiment of the present invention is shown to comprise a sunshade unit 2, a guide unit 3, and a buffer unit 4. The sunshade assembly of the present invention is adapted to be installed on a door (not shown) of a vehicle to cover a corresponding side window (not shown).

The sunshade unit 2 includes a housing 21 having a top opening 211, a rewindable winding shaft 22 mounted rotatably in the housing 21, a sunshade cloth 23 unwindably wound around the winding shaft 22, and a pull rod 24 connected to one end of the sunshade cloth 23 that is distal from the winding shaft 22 and disposed external to the top opening 211. The sunshade unit 2 may further include at least one biasing element (not shown) having one end that is fixed, and another end connected to the winding shaft 22. The biasing element is rotatable along with the winding shaft 22 to provide a winding biasing force to the winding shaft 22 along a winding direction. That is, in the absence of an external force, the sunshade cloth 23 is automatically wound into the housing 21 by the winding shaft 22.

The guide unit 3 includes a tubular casing 31 mounted below the housing 21 and extending in a top-bottom direction, and a guide rod 32 extending downwardly from the pull rod 24 and slidable in the tubular casing 31. The tubular casing 31 defines a guide groove 311 extending in a top-bottom direction, and has a slot 312 extending in a top-bottom direction at a bottom portion of the tubular casing 31.

The buffer unit 4 includes a mounting frame 41 connected to the bottom portion of the tubular casing 31, a buffer 42 mounted to the mounting frame 41 beside the tubular casing 31 to provide a buffer resistance to the guide rod 32, a driven member 43 driven by the guide rod 32 and moving the buffer 42, and a biasing element 44 disposed on the bottom portion of the tubular casing 31 and abutting against the driven member 43. The buffer 42 includes a mounting plate 421 mounted to the mounting frame 41 and facing the tubular casing 31, and a pinion 422 mounted rotatably to the mounting plate 421. Since the structure of the buffer 42 is conventional and is not an important aspect of the present invention, a detailed description of the same is dispensed with.

The driven member 43 includes a rack bar 431 extending in a top-bottom direction and meshed with the pinion 422, and a leg 432 connected to the rack bar 431 and extending into the tubular casing 31 below the guide rod 32. The leg 432 extends from a bottom end of the rack bar 431 into the guide groove 311 through the slot 312, and is slidable upward and downward along the slot 312. The biasing element 44 is configured as a compression spring that is disposed on the bottom portion of the tubular casing 31 to bias the leg 432 upwardly.

The sunshade cloth 23 is movable between a stretched position externally of the housing 21, as shown in FIG. 2, and a wound position disposed within the housing 21, as shown in FIG. 3. If stretching of the sunshade cloth 23 is desired to cover sunlight, the pull rod 24 is pulled upward by a user to pull the sunshade cloth 23 out of the housing 21 via the top opening 211. The guide rod 32 moves upwardly along with the pull rod 24, and the winding shaft 22 stores a winding force. The pull rod 24 is moved upward until it is hooked and positioned to a hooking seat (not shown), thereby placing the sunshade cloth 23 to the stretched position shown in FIG. 2. At this time, the biasing element 44 biases the driven member 43 upwardly. Alternatively, the sunshade cloth 23 may be designed such that when it is pulled upward, it may stop at any desired level or height, so that the hooking seat and the pull rod 24 may be dispensed with.

If it is desired to shift the sunshade cloth 23 from the stretched position shown in FIG. 2 to the wound position shown in FIG. 3, the pull rod 24 is disengaged from the hooking seat. Through a winding action of the winding shaft 22, the pull rod 24 and the guide rod 32 can move downward quickly until the guide rod 32 steps on and pushes the leg 432 and thus the driven member 43 downward. The rack bar 431 drives rotation of the pinion 422 so that the rack bar 431 can slowly move downward to retard downward moving speed of the guide rod 32 and to gradually reduce the winding speed of the sunshade cloth 23 until the guide rod 32 comes to a full stop and the sunshade cloth 23 is in the wound position. Hence, the guide rod 32 is prevented from directly bumping onto the housing 21.

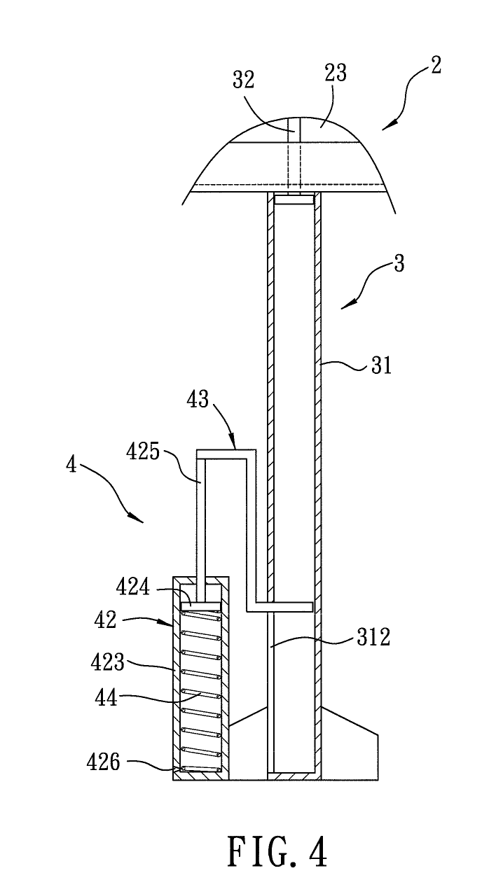

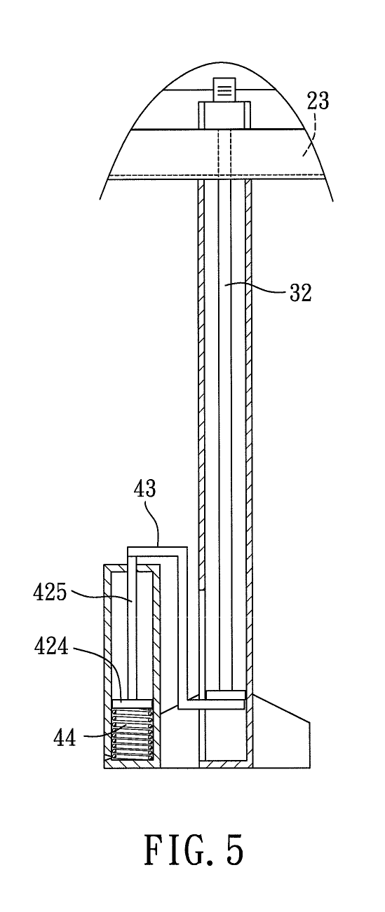

Referring to FIGS. 4 and 5, a sunshade assembly according to the second preferred embodiment of the present invention is shown to be similar to the first preferred embodiment. However, in this embodiment, the buffer 42 includes a hollow cylinder 423 for containing fluid, a piston 424 mounted movably in the cylinder 423, and a piston rod 425 extending through a top end of the cylinder 423 and connected to the piston 424. The cylinder 423 contains air for providing a buffer resistance, and has at least one vent hole 426 formed in a bottom end thereof. As the piston 424 presses down the fluid, pressure is slowly released. Alternatively, when the cylinder 423 contains liquid, the vent hole 426 is dispensed with. In this embodiment, the driven member 43 is configured as a Z-shaped rod having one end connected to the piston rod 425, and another end extending into the guide groove 311 via the slot 312 and below the guide rod 32. The biasing element 44 is disposed inside the cylinder 423, and biases the piston 424 and the piston rod 425 upward.

When the sunshade cloth 23 is shifted from the stretched position shown in FIG. 4 to the wound position shown in FIG. 5, the guide rod 32 guides the driven member 43 to move downward, and the piston rod 425 and the piston 424 also move downward to press the fluid and provide a buffer resistance to the driven member 43 and the guide rod 32. Similarly, the downward moving speed of the guide rod 32 and the speed of winding the sunshade cloth can be reduced gradually.

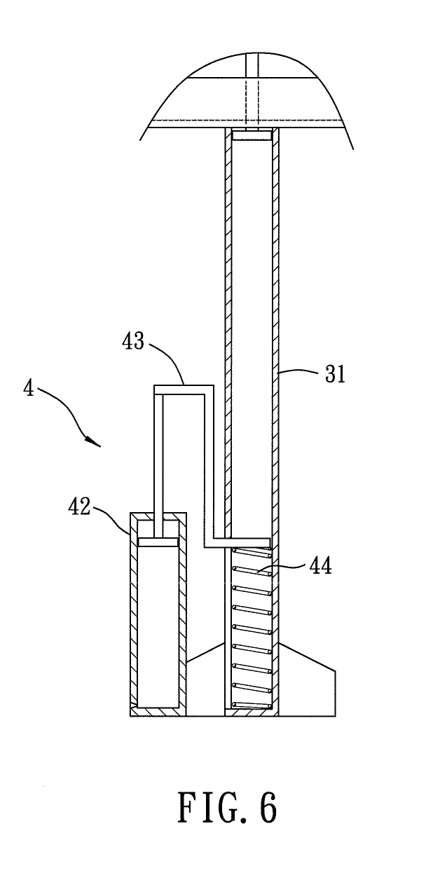

Referring to FIG. 6, a sunshade assembly according to the third preferred embodiment of the present invention is shown to be similar to the second preferred embodiment. However, in this embodiment, the biasing element 44 is disposed in the bottom portion of the tubular casing 31, and biases the driven member 43 upwardly.

From the aforesaid description of the sunshade assembly of the present invention, it is apparent that by mounting the guide unit 3 with the buffer unit 4 to provide a buffer resistance, the downward moving speed of the guide rod 32 and the speed of winding the sunshade cloth 23 can be slowed down when the sunshade cloth 23 nears its complete winding onto the winding shaft 22, thereby preventing the guide rod 32 from impacting other components that will produce noise and vibration. Hence, the present invention can effectively minimize noise and vibration during winding of the sunshade cloth 23, so that the sophistication of the product can be enhanced and the object of the present invention can be realized.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A sunshade assembly comprising:
a sunshade unit including a housing having a top opening, a winding shaft mounted rotatably in said housing, a sunshade cloth wound around said winding shaft, and a pull rod connected to one end of said sunshade cloth that is distal from said winding shaft and disposed external to said top opening;
a guide unit including a tubular casing mounted below said housing and extending in a top-bottom direction, and a guide rod extending downward from said pull rod and slidable in said tubular casing; and
a buffer unit including a buffer disposed beside said tubular casing to provide a buffer resistance to said guide rod, and a driven member driven by said guide rod and that moves said buffer;
wherein, when said sunshade cloth is moved by said winding shaft to a wound position from a stretched position externally of said housing, said guide rod is moved downward along with said pull rod until said guide rod pushes downward said driven member, thereby reducing a downward moving speed of said guide rod.

2. The sunshade assembly of claim 1, wherein said buffer includes a mounting plate, and a pinion mounted rotatably to said mounting plate, said driven member including a rack bar extending in a top-bottom direction and meshed with said pinion, and a leg connected to said rack bar and extending into said tubular casing below said guide rod, said rack bar driving rotation of said pinion when said guide rod pushes downward said leg to retard downward moving speed of said guide rod.

3. The sunshade assembly of claim 2, wherein said buffer further includes a biasing element disposed on a bottom portion of said tubular casing to bias upwardly said leg.

4. The sunshade assembly of claim 3, wherein said tubular casing includes a slot extending in a top-bottom direction at said bottom portion of said tubular casing, said leg extending into said tubular casing through said slot and being slidable upward and downward along said slot.

5. The sunshade assembly of claim 1, wherein said buffer includes a hollow cylinder for containing fluid, a piston mounted movably in said cylinder, and a piston rod extending through a top end of said cylinder and connected to said piston, said driven member being connected to said piston rod and extending into said tubular casing below said guide rod.

6. The sunshade assembly of claim 5, wherein said buffer unit further includes a biasing element disposed in said cylinder to bias upward said piston.

7. The sunshade assembly of claim 5, wherein said buffer unit further includes a biasing element disposed on a bottom portion of said tubular casing to bias upward said leg.

8. The sunshade assembly of claim 5, wherein said cylinder is adapted to contain air, and has a vent hole formed in a bottom end thereof.

9. The sunshade assembly of claim 5, wherein said tubular casing includes a slot extending in a top-bottom direction at a bottom portion of said tubular casing, said leg extending into said tubular casing through said slot and being slidable upward and downward along said slot.
